(19) United States
(12) Patent Application Publication
(10) Pub. No.: US 2015/0083653 A1
(43) Pub. Date: Mar. 26, 2015

(54) DEVICE FOR PURIFYING WATER OF A CONTAINER

(71) Applicant: Silvano MARCOLONGO, Grisignano di Zocco (IT)

(72) Inventor: Silvano MARCOLONGO, Grisignano di Zocco (IT)

(21) Appl. No.: 14/556,268

(22) Filed: Dec. 1, 2014

Related U.S. Application Data
(63) Continuation-in-part of application No. PCT/EP2013/060970, filed on May 28, 2013.

(30) Foreign Application Priority Data
May 29, 2012 (IT) PD2012A000170

(51) Int. Cl. C02F 1/50

(52) U.S. Cl. CPC C02F 1/505; C02F 2307/04
USPC 210/198.1

(57) ABSTRACT

A device (10, 110) for purifying water, particularly but not exclusively for domestic use, comprising a metallic body (11, 111) to be inserted in a container (12, 112) of water (13) to be purified, the metallic body (11, 111) having a face (14, 114) made of silver and an opposite face (15, 115) made of brass, both intended to come into contact with the water (13).

The present invention relates to a device for purifying water of a container.

Although the water distributed by the public water supply is usually potable and thus suitable for normal alimentary uses, it often has unpleasant organoleptic characteristics, which are due for example to the presence of chlorine, impurities or other substances dissolved therein.

Moreover, if drawn from accumulation receptacles, it has the potential for biological pollution.

As is known, in order to render drinking water more pleasant the use is currently widespread of filtering jugs, which are provided on the inside with cartridges capable of purifying the water.

The cartridges, in fact, filter impurities out of the water and reduce the timescale content and the presence of other substances present therein which alter its flavor and odor, such as chlorine and some organic impurities.

Such cartridges however exhibit the drawback of losing their efficacy over time and therefore, for the filtering jug to function correctly, they must be regularly replaced.

Also known are some metallic devices for immersion in the water in order to protect containers and pipes from bacterial corrosion, or with bactericidal effect, such as the devices disclosed in documents nos. FR2087553 and WO2011139835.

Such devices substantially take advantage of the direct action of the silver ions that are released into the water in order to break down the bacterial structures, while the other alloys are present so as to neutralize the presence of silver ions in the water, which can be harmful to health.

The antibacterial properties of silver and other metals like copper have been known for long. It is known, for instance, that the presence of one part in 100 million parts of elemental silver in solution allows to produce an effective antimicrobial action. The bactericidal effect is obtained when available silver ions in the water interact with the bacterial surface. The effectiveness of the bactericidal action in the water depends on the concentration of metal ions and on the type of metal or their mixture. It is known the use of silver for bactericidal effects in many applications and, for example, it is used in filters for water purification.

The difficulties of the known devices up to now regard the difficulty of providing a correct number of ions available in the water for the intended use.

Are also known techniques of silver deposition onto materials without the use of binders with complex deposition techniques, like systems with vacuum evaporation or with techniques of photo reduction. By means of these techniques it is possible to deposit a layer of silver on surfaces also in the form of small aggregates of silver. Such engineered materials with antibacterial properties however do not allow to make available in the drinking water an optimal number of metal ions for the antibacterial activity.

It is also known that the metals in water tend to oxidize i.e. to lose electrons to become positive ions; the latter are then subject to be more easily hydrolyzed and to go into solution. It is also possible that a metal positive ion reacts with an anion (negative ion) present in the water to favourite the hydrolyzation. The electrochemical reactions of corrosion which allow to the ions of metal to hydrolyze and pass in solution imply the presence of oxidation processes that release electrons and reduction processes that consume them.

The known devices to reduce the bacteria in the water have resulted unsuitable for the bad choice of the shape and of the metal material used to realize the devices intended to entry into contact with the water in order to generate a precise charge of ions with optimal bactericidal action. In fact the devices used until now are resulted to have a overly aggressive charge of metal ions, and therefore dangerous for the health, or excessively small charge of ions, and therefore with a poor bactericidal effect. Moreover, the devices hitherto used are mostly suitable to be used in a continuous flow of water (as for example the equipment described in French patent FR 7018793).

The aim of the present invention is to provide a device for purifying water which causes bacterial abatement, including the capability to combat the legionella bacteria.

Within this aim, an object of the invention is to provide a device that is structurally simple and practical to use.

Another object of the invention is to provide a device that makes it possible to purify water in containers of various types, not solely jugs, thus being usable in industry as well.

Another object of the invention is to provide a device to be used for the conservation of liquid and semi-liquid foods.

This aim and this and other objects which will become more evident hereinafter are achieved by a device for purifying water, particularly but not exclusively for domestic use, characterized in that it comprises a metallic body to be inserted in a container of water to be purified, said metallic body having a face made of silver and an opposite face made of brass, both intended to come into contact with the water.

Further characteristics and advantages of the invention will become more apparent from the description of two preferred, but not exclusive, embodiments of the device according to the invention, illustrated by way of non-limiting example in the accompanying drawings wherein:

FIG. 1 is a perspective view of the device according to the invention in a first embodiment;

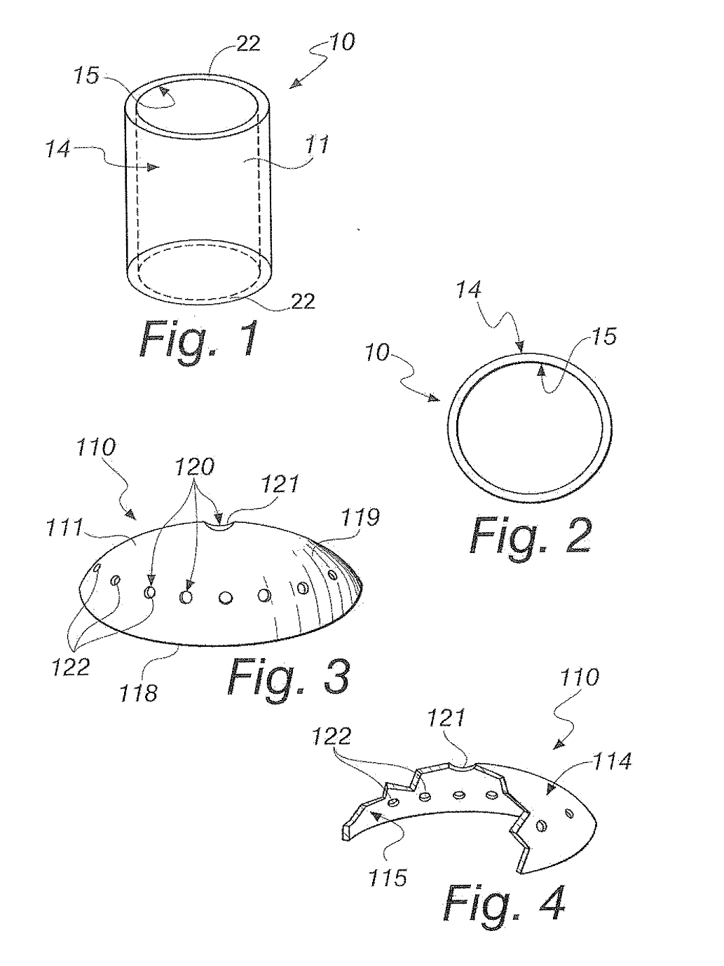

FIG. 2 is a view from above of the device shown in FIG. 1;

FIG. 3 is a perspective view of the device according to the invention in a second embodiment;

FIG. 4 shows, from the same viewpoint as in FIG. 3, the device partially cut away, again in the second embodiment;

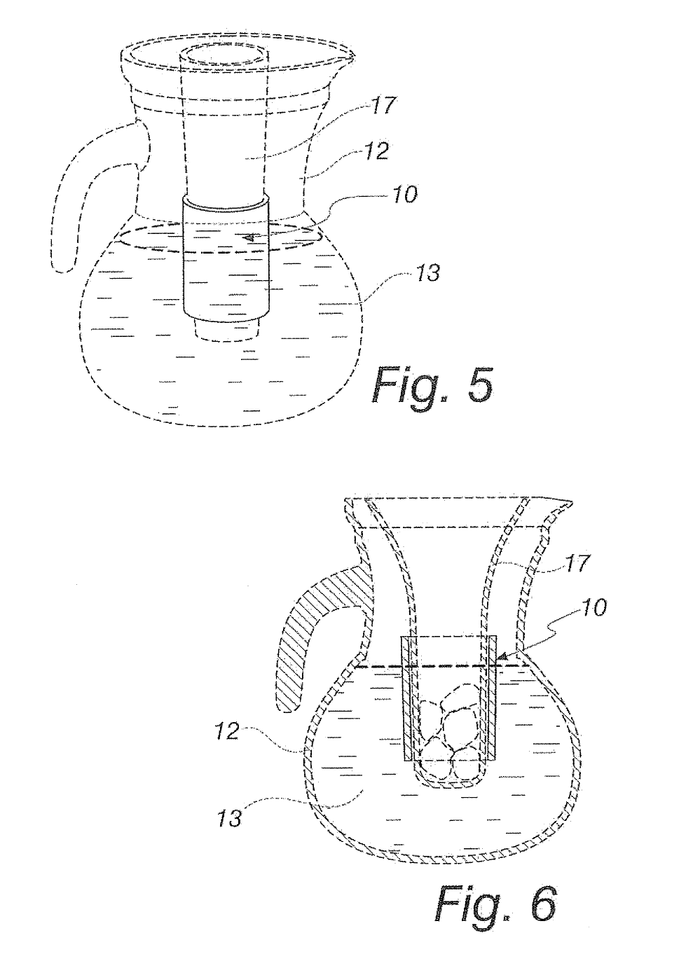

FIG. 5 is a perspective view of an example of a possible application of the device according to the invention in its first embodiment;

FIG. 6 is a sectional side view of the example shown in FIG. 5;

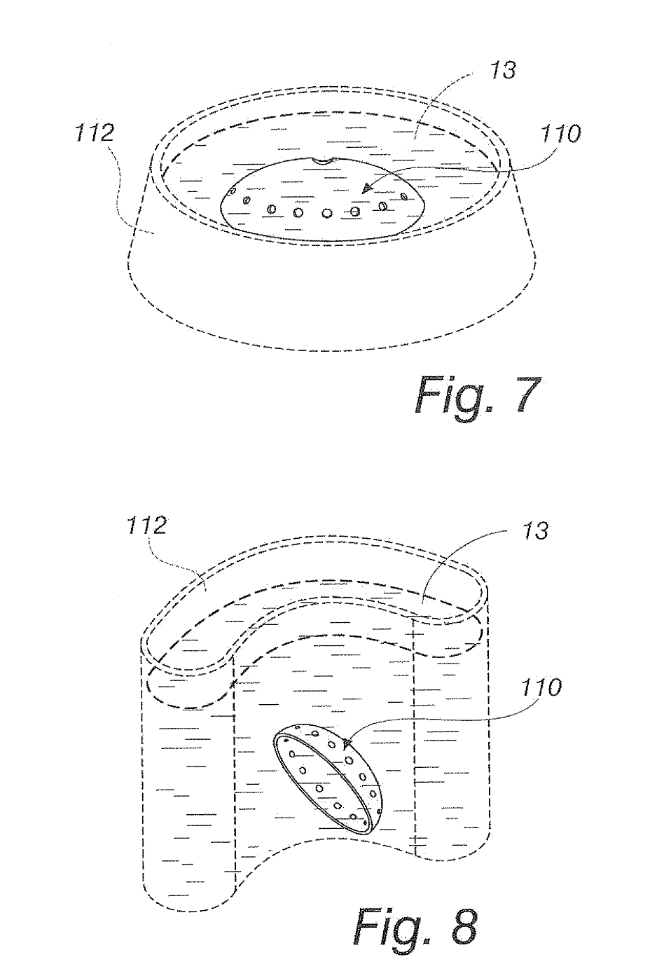

FIG. 7 shows an example of a possible application of the device according to the invention in its second embodiment;

FIG. 8 shows an example of another application of the device according to the invention in its second embodiment;

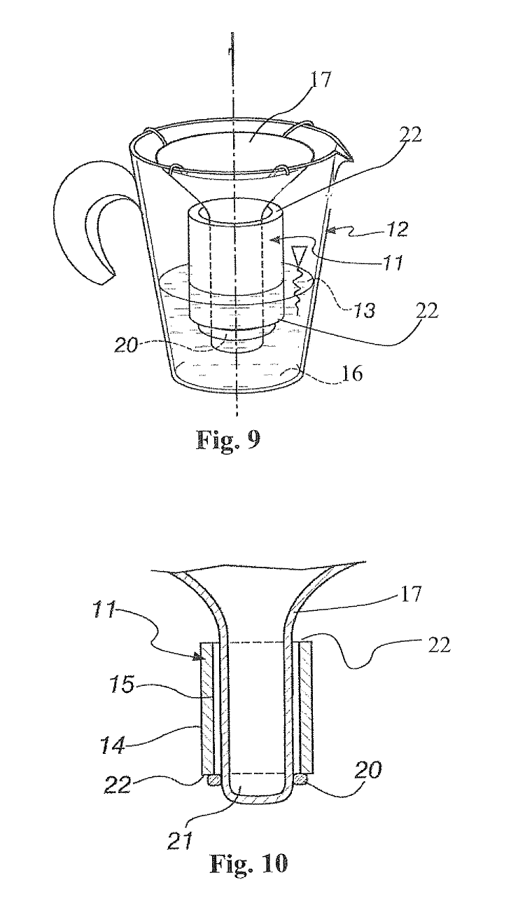

FIG. 9 is a perspective view of an another example of a possible application of the device according to the invention in its first embodiment;

FIG. 10 is a particular in side sectional view of the example shown in FIG. 9;

FIG. 11 is a perspective view of an another example of a possible application of the device according to the invention in its first embodiment;

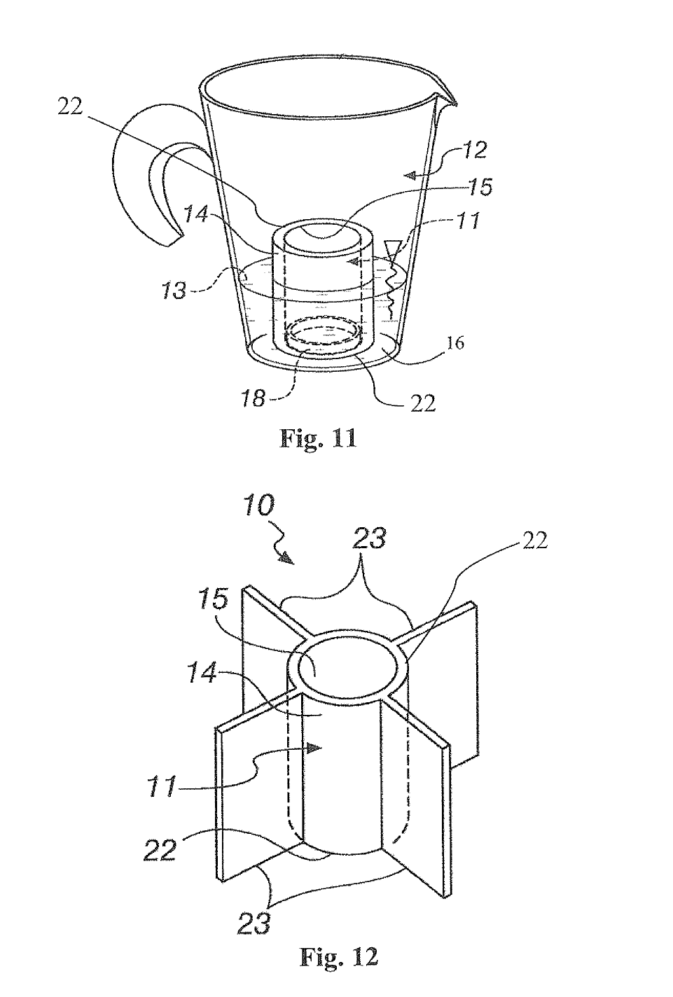

FIG. 12 is a perspective view of the embodiment of the device according to the invention in its first embodiment modified by adding some radial wings.

With reference to the figures, the device according to the invention, designated with the reference numeral 10 in its first embodiment, comprises a metallic body 11 to be inserted in a container 12 of water 13 to be purified.

The metallic body 11 has a face 14 made of silver and an opposite face 15 made of brass, both intended to come into contact with the water 13.

The device 10 purifies the water due to the exchange of electrons between the two opposite faces, made of silver 14 and made of brass 15, and these can be made, alternatively, with different alloys in order to achieve the same effect, respectively of alloys of silver and of alloys of copper.

In the specific shape structures proposed, it is constituted by a hollow brass body which is provided with a silver plating on its face 14 and is substantially shaped like a tubular body which is open at its two ends with two end openings 22.

As shown in FIG. 1 the face 14 made of silver and the opposite face 15 made of brass constitute respectively the outer face and the inner face of the tubular body.

In the example of application shown in FIGS. 5, 6, 9-12, the container 12 is constituted by a jug which is provided with an ice bucket 17, circular in cross-section, over which the metallic body 11 is fitted.

The metallic body 11 conveniently has an oval cross-section which is constant over its whole length, with the smaller diameter substantially equal to the diameter of the ice bucket 17, so as to engage with it by interference.

The larger diameter is sufficiently large to determine, laterally to the ice bucket 17, two spaces between the ice bucket 17 and the opposite face 15 which can be occupied by the water 13, which therefore in this manner flows over both of the faces 14 and 15.

With reference to the embodiment of FIG. 9 the metallic tubular body 11 is supported at its open end 22 by a ring 20 (or by an equivalent support protruding outward from the bucket) mechanically fixed along the longitudinal extension of the bucket, in particular in correspondence of its lower end 21.

The metallic body 11 may be placed with its open end 22 on the bottom 16 of a container 12, such as a jug, as illustrated in FIG. 11. In order to maintain the metallic body 11 in the stable e correct position within the container 12, the latter may be provided with a lip ring 18 projecting from the bottom 16 and suitable to engage with the open end 22 of the metallic tubular body 11.

Differently, in accordance with the teaching of FIG. 12, the metallic body 11 may be provided with radial wings 23 (advantageously still externally coated with silver) which will be suitable to rest against the inner surface of the container 12 to block the metallic body 11 in its inside.

The device 10 can be advantageously used to combat legionella.

In the second embodiment of the device 110, shown in FIGS. 3, 4, 7 and 8 the metallic body 111 is to be immersed in a container 112, which can be for example a bowl for pet animals, as in FIG. 7, or a tub of water for coffee machines, as shown in FIG. 8. The metallic body 110 is again internally hollow and made of brass, but in this case it has a concave hollow shaped cavity that is substantially dome-shaped with an open base 118.

More in detail, as in the previous embodiment the metallic body 111 has two openings that in this case are:
the open base 118 suitable to rest onto the container and
at least an opening 120 which crosses the thickness of the metallic body and is able to allow the water to reach the cavity.

As in the previous embodiment, the face 114 made of silver and the opposite face 115 made of brass constitute respectively the outer face and the inner face of the dome.

As in the previous embodiment, the device 110 can be used to combat legionella and it purifies the water by means of the exchange of electrons between the two opposite faces, made of silver 114 and made of brass 115, and these can be made, alternatively, with different alloys in order to achieve the same effect, respectively of alloys of silver and of alloys of copper.

The wall 119 of the dome is crossed in its thickness by a plurality of openings 120 through which the water 13 passes.

Such openings 120 comprise a main hole 121 in a position which is opposite to the base 118 and a series of secondary holes 122 in the wall 119, in the region of the metallic body 111 comprised between the base 118 and the main hole 121.

The use of the device 10 according to the invention is as follows.

In its first embodiment the device 10 is fitted over the ice bucket 17 and immersed with it in the water 13 of the jug, while in the second embodiment the device 110 is simply inserted into the container 112 with water 13 and settles on the bottom thereof.

For the correct operation of the device 10, as with the device 110, both of the faces, 14 and the opposite one 15, must be in contact with the water 13. In this regard it should be noted that the oval-shaped cross-section allows the passage of water 13 between the wall, of the ice bucket 17 and the face 15.

In the second embodiment the openings 120 are crossed by the water, promoting the descent of the device 110 to the bottom of the container 112.

The device 10, 110 according to the invention, in order to have its effect, must remain in the container 12 or 112 at least partially immersed in the water 13 and for at least a quarter of an hour.

In fact, the electrification owing to the movement of charges kills the bacterial population, thus generating such bactericidal effect.

From laboratory tests conducted on samples of mains water, it is effective in killing bacteria, not only such as legionella, but also Gram+ and Gram− bacteria such as pseudomonas aeruginosa and E. coli, even after artificial inoculation thereof.

For example, from a test conducted on a sample of potable water in a jug, thirty minutes after insertion of the device 10 or 110 the following variation was observed in the parameters given below:

Free chlorine from 0.13 mg/l to 0.03 mg/l,

Colony count at 22° C. from 15 UFC/ml to 5 UFC/ml,

Colony count at 36° C. from 17 UFC/ml to 6 UFC/ml,

Coliform bacteria count from 9 UFC/100 ml to 6 UFC/ml.

From a sampling executed after inoculation of 320 UFC/ml of Pseudomonas aeruginosa, already after an hour and for up to five days of immersion of the device in the water, the bacteria were absent.

The antibacterial activity of the device was also tested on controlled contamination suspensions prepared using certified bacterial strains of the Legionella pneumophila ATCC 33152 and Escherichia coli ATCC 8739, previously placed in culture. The concentration of the bacterial suspensions used in the tests is approximately 3×10̂3 cell/mL

The base antibacterial efficacy was evaluated by immersing the metallic device in an initial volume of bacterial suspension of 1 liter, and for each test the nitrocellulose membrane filtration technique was used.

The test on Legionella pneumophila was conducted with reference to the protocol for searching for Legionella in environmental samples, in accordance with the Italian guidelines for the prevention and control of legionellosis, whereas the test on Escherichia coli was conducted with reference to the method for determining Escherichia coli in water, described in the ISTISAN 07/5 Reports.

During the test, the values of the bacterial load were compared over time without the device and with the device immersed in the solution.

The effect in reduction of the bacterial load was evident starting from one hour of time spent in contact with the contaminated liquid; for contact times less than one hour the effect is not evident.

For Legionella pneumophila, the values of the bacterial load as a function of time without the device and with the device immersed in the solution are respectively:

15.2×10̂4 UFC/L and 14.7×10̂4 UFC/L at test start,

12.8×10̂4 UFC/L and 24.4×10̂4 UFC/L after 15 minutes,

19.6×10̂4 UFC/L for both after 30 minutes,

17.0×10̂4 and 89×10̂3 after one hour,

8.6×10̂4 and 65×10̂3 after 24 hours,

16.2×10̂4 and 13×10̂3 after 48 hours.

For Escherichia coli the following values of bacterial load were found as a function of time, again respectively without the device and with the device immersed in the solution:

276.5×10̂2 UFC/100 ml and 296.5×10̂2 UFC/100 ml at test start,

232×10̂2 UFC/100 ml and 142.5×10̂2 UFC/100 ml after one hour,

226×10̂2 UFC/100 ml and 0 UFC/100 ml after 24 hours,

194×10̂2 UFC/100 ml and 0 UFC/100 ml after 48 hours.

Reuse of the device simply requires its extraction from the container and washing with running water with each use.

It can be used for purifying water for various uses: drinking water, which after the treatment is more pleasant from an organoleptic viewpoint, but also water for industrial use or for plumbing systems of structures both private and public, such as for example swimming pools, hotels and hospitals, especially in connection with the anti-legionella action.

The present invention has surprisingly brought to light that providing a bi-component body made of silver and brass together with the advantageous shape of the same product, that body suitable to promote the water flow in contact with the two-component body, allows to bring in the water solution through a redox process, a mixture of ions capable of producing a high bactericidal action, maintaining the potability of the drinking water. The water is in other words drinkable without any particular health problem and is at the same time bacteriologically sanitized.

The redox reaction has revealed to be controlled in an optimal manner by the presence of a plate body having a layer of brass and an layer of silver with contact surface there between, capable of forming an electrical connection for exchange electrons suitable to close the circuit of the redox reaction.

The device needs to operate in accumulation receptacles.

In practice it has been found that the invention achieves the set objective in that makes it possible to obtain a significant reduction of bacterial content.

Another advantage of the device according to the invention is that it is simple and practical to use, as well as being structurally simple.

Moreover, since it can be reused repeatedly, its contribution to environmental pollution associated with the disposal of refuse is lower than that of previously known water purification devices.

Another advantage of the device is that it can also be used for other liquids, such as milk, tea, wine and other beverages in general, in order to improve their microbiological conservation, but also for semi-solid foods, such as cream which typically is subject to rapid degradation, since it acts as a bacterial inhibitor.

The device, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. PD2012A000170 from which this application claims priority are incorporated herein by reference.

Where technical features mentioned in any claim are followed by reference signs, such reference signs have been inserted for the sole purpose of increasing the intelligibility of the claims and accordingly such reference signs do not have any limiting effect on the interpretation of each element identified by way of example by such reference signs.

1. A device for purifying water of a container comprising a metallic body (11, 111) having a plate shape, and able to be inserted in a container (12, 112) of water (13) to be purified, said metallic body (11, 111) having a first face (14, 114) made of silver and a second face (15, 115), oriented in the opposite direction with respect to the first face, made of brass, both intended to come into contact with the water (13);
wherein said metallic body (11, 111) has:
a concave hollow shaped cavity with an open base (118) suitable to rest onto the container (12, 112);
and at least one opening (120) which crosses the thickness of the metallic body (11, 111) and is able to allow the water to reach the cavity.

2. The device according to claim 1, characterized m that said at least one opening (120) comprises a main hole (121) in a position which is opposite to said base (118).

3. The device according to claim 2, characterized in that said at least one opening (120) comprises a series of secondary holes (122) in the wall (119) of said metallic body (111) in the region comprised between said open base (118) and said main hole (121).

4. The device according to claim 1, characterized in that said cavity has the first face (14, 114) made of silver at the external convex surface and the second face (15, 115) made of brass at the internal concave surface.

5. The device according to claim 1, characterized in that said concave hollow shaped cavity is substantially dome-shaped, with a wall (119) which is crossed in its thickness by said at least one opening (120).

6. A device (10) for purifying water of a container, particularly but not exclusively for domestic use, characterized in that it comprises a metallic body (11, 111) having a plate shape, and able to be inserted in a container (12, 112) of water (13) to be purified, said metallic body (11, 111) having a first face (14, 114) made of silver and a second face (15, 115), oriented in the opposed direction with respect to the first face, made of brass, both intended to come into contact with the water (13);
wherein said metallic body (11, 111) is shaped like a tubular body with two end openings (22).

7. The device according to claim 6, characterized in that said tubular body has the first face (14) made of silver at the external convex surface and the second face (15) made of brass at the internal concave surface.

8. The device according to claim 6, characterized in that said metallic body (11) has an oval cross-section which is constant over its longitudinal length.

9. The device according to claim 7, characterized in that said metallic body (11) has a plurality of wings (23) extending radially from the outer surface (14) of the tubular body and that are suitable to rest against the internal surface of said container (12, 112).

10. The device according to claim 6, characterized in that said metallic body (11) is suitable to be fitted over an ice bucket (17), circular in cross-section, of a jug which constitutes said container (12), the smaller diameter of said oval cross-section of said metallic body (11) being substantially equal to the diameter of said ice bucket (17).
